(19) United States
(12) Patent Application Publication
(10) Pub. No.: US 2014/0134401 A1
(43) Pub. Date: May 15, 2014

(54) MAGNETIC SHEET AND METHOD FOR MANUFACTURING THE SAME

(71) Applicant: Samsung Electro-Mechanics Co., Ltd., Gyeonggi-do (KR)

(72) Inventors: Jung Tae Park, Gyeonggi-do (KR); Jong Deuk Kim, Gyeonggi-do (KR); Sung Yong An, Gyeonggi-do (KR); Dong Hyeok Choi, Gyeonggi-do (KR); Seung Heon Han, Gyeonggi-do (KR)

(73) Assignee: Samsung Electro-Mechanics Co., Ltd., Gyeonggi-do (KR)

(21) Appl. No.: 14/030,996

(22) Filed: Sep. 18, 2013

(30) Foreign Application Priority Data
Nov. 15, 2012 (KR) 10-2012-0129445

(51) Int. Cl. H01F 41/22; H01F 10/26

(52) U.S. Cl. CPC H01F 41/22; H01F 10/26
USPC 428/155; 427/130; 264/611; 156/89.11

(57) ABSTRACT

Disclosed herein is a magnetic sheet capable of having flexibility and being folded, and a method for manufacturing the same. The magnetic sheet made of a magnetic material includes prominence and depression parts continuously formed over one surface of the magnetic sheet; and cracks formed between a bottom surface of the prominence part and a lower surface of the magnetic sheet.

### CROSS REFERENCE(S) TO RELATED APPLICATIONS

This application claims the benefit under 35 U.S.C. Section 119 of Korean Patent Application Serial No. 10-2012-0129445, entitled “Magnetic Sheet and Method for Manufacturing the Same” filed on Nov. 15, 2012, which is hereby incorporated by reference in its entirety into this application.

### BACKGROUND OF THE INVENTION

1. Technical Field

The present invention relates to a magnetic sheet and a method for manufacturing the same, and more particularly, to a magnetic sheet having prominence and depression parts and a method for manufacturing the same.

2. Description of the Related Art

Recently, a radio frequency identification system (hereinafter, referred to as an “RFID system”) transmitting and receiving data between a transponder having an integrated circuit (IC) chip and a reader/a writer or a transponder and a reader has spread. Since the RFID system uses an antenna provided in the transponder and the reader/the writer, respectively, to wirelessly transmit and receive the data, even though the transponder is separated from the reader/the writer by several mm to several cm, the communication is possible without requiring contact with each other. In addition, since the RFID system is strong against contamination, static electricity, and the like, it is used in various fields such as production management of a factory, logistics distribution and inventory management, management of entering and leaving a room, and the like.

The antenna which is an essential component for transmitting and receiving the data in the RFID system is configured of a flexible printed circuit board (FPCB), and generally has a thickness of 0.3 to 0.8 mm. Here, a magnetic sheet is adhered to the antenna in order to complement stability of an antenna signal and a decay of the signal due to surrounding metal materials.

That is, in the case in which a conductive member such as a metal is present around the antenna, for example, at the rear of the antenna, antenna characteristics may be deteriorated by an electric wave reflected by the conductive member, such that a magnetic material having high permeability is adhered to the rear of the antenna between the antenna and the conductive member, thereby suppressing the reflection of the electric wave.

Regarding this, when reviewing the magnetic sheet disclosed in Japanese Patent Laid-Open Publication No. 2005-015293, even in the case in which the object has a curved surface, or an uneven surface, one surface of the magnetic sheet is provided with a groove to have flexibility so that the magnetic sheet is stably adhered to an object to be adhered.

However, in order to provide the groove on one surface of the magnetic sheet, a half cut process is necessarily performed on the surface of the sintered magnetic sheet, wherein the magnetic sheet generally has a thickness of 0.1 mm to 5 mm, such that the half cut process having high precision should be performed.

Therefore, even though a minor error occurs at the half cut process, a defect that the magnetic sheet is cut may be generated, and in the case in which the thickness of the magnetic sheet has a deviation, the cutting depth needs to be changed for each part, such that productivity is deteriorated, and manufacturing cost is high.

In addition, even though there is the groove on the surface of the magnetic sheet, the magnetic sheet itself cannot be folded. Therefore, in the case in which the object to be adhered has an excessively curved portion having 90 degrees or more, it is difficult to stably adhere the magnetic sheet to the object.

### RELATED ART DOCUMENT

### Patent Document

(Patent Document 1) Japanese Patent Laid-Open Publication No. 10-2005-015293

### SUMMARY OF THE INVENTION

An object of the present invention is to provide a magnetic sheet capable of having flexibility, being folded to be more flexible with respect to an object to be adhered, and being manufactured by a simple method to thereby increase productivity of a product and decrease manufacturing cost, and a method for manufacturing the same.

According to a first exemplary embodiment of the present invention, there is provided a magnetic sheet made of a magnetic material including: prominence and depression parts continuously formed over one surface of the magnetic sheet; and cracks formed between a bottom surface of the prominence part and a lower surface of the magnetic sheet.

The prominence part and the depression part may have ‘ [symbol] ’ a shape, respectively.

The prominence part may have a transversal width corresponding to 0.5 to 1.5 of a transversal width of the depression part.

The prominence part may have a longitudinal width corresponding to 0.5 to 1.5 of a longitudinal width of the depression part.

The prominence and depression part may have a thickness 0.5 to 1.5 of a spaced distance between a bottom surface of the prominence part and a lower surface of the magnetic sheet.

The magnetic sheet may further include a protective film adhered to a surface on which the prominence and depression part is formed in the magnetic sheet, and an adhesive film adhered to an opposite surface to the surface on which the prominence and depression part is formed.

According to a second exemplary embodiment of the present invention, there is provided a method for manufacturing a magnetic sheet, the method including: (a) preparing a green sheet made of a magnetic material; (b) positioning a screen on the green sheet, the screen including rectangular shaped opening parts continuously formed on the entire surface thereof; (c) transferring a magnetic paste on a surface of the green sheet exposed through the opening part; (d) forming the magnetic sheet having prominence and depression parts on one surface through a sintering process; and (e) performing a breaking process to form cracks between a bottom surface of the prominence part and a lower surface of the magnetic sheet.

The opening part may have a longitudinal width corresponding to 0.5 to 1.5 of a spaced distance between the opening parts in a longitudinal direction.

The opening part may have a transversal width corresponding to 0.5 to 1.5 of a spaced distance between the opening parts in a transversal direction.

The opening part may have a thickness corresponding to 0.5 to 1.5 of a thickness of the green sheet.

The method may further include, after the forming of the magnetic sheet, adhering a protective film to a surface on which the prominence and depression part is formed, and adhering an adhesive film to an opposite surface to the surface on which the prominence and depression part is formed.

According to a third exemplary embodiment of the present invention, there is provided a method for manufacturing a magnetic sheet, the method including: (a) positioning a screen so as to be spaced apart from a flat panel by a predetermined interval, the screen including rectangular shaped opening parts continuously formed on the entire surface thereof; (b) transferring a magnetic paste on the screen; (c) sintering a molding body formed by the transferring of the magnetic paste to form a magnetic sheet having a prominence and depression part on one surface thereof; and (d) performing a breaking process to form cracks between a bottom surface of the prominence part and a lower surface of the magnetic sheet.

### BRIEF DESCRIPTION OF THE DRAWINGS

FIG. 1 is a cross-sectional view of a magnetic sheet according to an exemplary embodiment of the present invention;

FIG. 2 is a plan view of the magnetic sheet according to the exemplary embodiment of the present invention;

FIGS. 3 to 6 are views sequentially showing a method for manufacturing the magnetic sheet according to the exemplary embodiments of the present invention; and

FIGS. 7 to 8 are views sequentially showing another method for manufacturing the magnetic sheet according to the exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

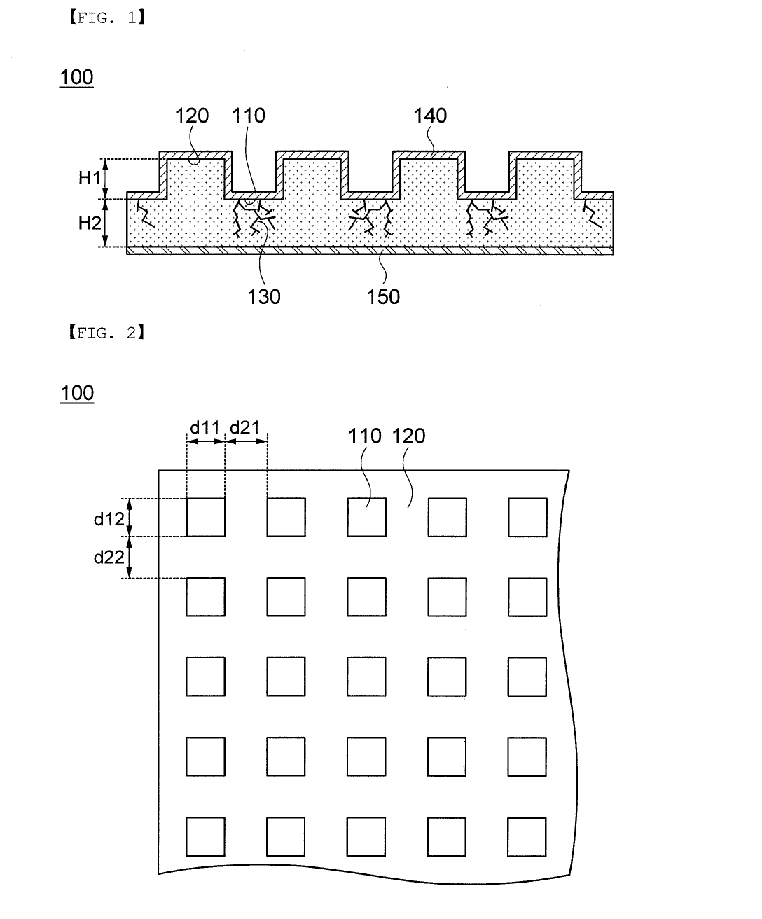

FIG. 1 is a cross-sectional view of a magnetic sheet according to an exemplary embodiment of the present invention and FIG. 2 is a plan view of the magnetic sheet according to the exemplary embodiment of the present invention. Additionally, components shown in the accompanying drawings are not necessarily shown to scale. For example, sizes of some components shown in the accompanying drawings may be exaggerated as compared with other components in order to assist in the understanding of the exemplary embodiments of the present invention.

Referring to FIGS. 1 and 2, a magnetic sheet 100 according to the exemplary embodiment of the present invention has prominence parts 110 and depression parts 120 continuously formed over one surface thereof.

The magnetic sheet 100 may be made of known ferrite having high permeability and a soft magnetic metal material. For example, the magnetic sheet 100 may be made of any one or two or more compositions of Mn—Zn, Ni—Zn, Fe—Mn, Ni—Zn—Cu, Mn—Mg, Li, and Ba.

It is preferable that the prominence part 110 and the depression part 120 continuously formed over one surface of the magnetic sheet 100 have a ‘ [symbol] ’ shape, and the prominence part 110 has a transversal width d11 corresponding to 0.5 to 1.5 of a transversal width d21 of the depression part 120. Similarly, it is preferable that the prominence part 110 has a longitudinal width d12 corresponding to 0.5 to 1.5 of a longitudinal width d22 of the depression part 120.

In the case in which a ratio of the transversal width d11 or the longitudinal width d12 of the prominence part 110 is out of the above-mentioned range, an interval between the depression parts 120 is excessively close or insufficient, such that the magnetic sheet 100 according to the exemplary embodiments of the present invention is not provided with flexibility. In addition, in a method for manufacturing the magnetic sheet 100 according to the exemplary embodiments of the present invention that will be described, the magnetic sheet 100 does not have directivity to a pressure to be applied, such that cracks cannot be formed at a desired portion.

Meanwhile, a thickness of the magnetic sheet needs to be appropriately set in consideration of contradictory relationship between permeability and thinning thereof. In the exemplary embodiment of the present invention, since the sum of a thickness H1 of the prominence and depression parts 110 and 120 and a spaced distance H2 between a bottom surface of the prominence part 110 and a lower surface of the magnetic sheet 100 is the same as the total thickness of the magnetic sheet, at the time of setting the thickness of the magnetic sheet 100 according to the exemplary embodiment of the present invention, it is important to appropriately set a ratio of the thickness H1 of the prominence and depression parts 110 and 120 and the spaced distance H2 between the bottom surface of the prominence part 110 and the lower surface of the magnetic sheet 100.

In the exemplary embodiments of the present invention, the prominence and depression parts 110 and 120 has the thickness H1 corresponding to 0.5 to 1.5 of the spaced distance H2 between the bottom surface of the prominence part 110 and the lower surface of the magnetic sheet 100. In the case in which the thickness H1 of the prominence and depression parts 110 and 120 is relatively large, the magnetic sheet 100 according to the exemplary embodiment of the present invention may have higher flexibility; however, a size of the prominence part 110 becomes large to deteriorate permeability.

That is, it is preferable that the thickness H1 of the prominence and depression parts 110 and 120 is set in consideration of the contradictory relationship between the desired effect and the desired permeability of the present invention. However, since the above-mentioned numerical range is a range for defining an optimum value at which an effect of the present invention may be implemented while fulfilling the required permeability, as long as a range satisfies the desired object of the present invention, even though the range is slightly out of the numerical range, it is reasonable that the range may be permitted by a person skilled in the art.

As another important characteristic according to the exemplary embodiment of the present invention, there may be cracks 130 formed between the bottom surface of the prominence part 110 and the lower surface of the magnetic sheet 100.

The crack 130 is irregularly formed by pressure applied to the magnetic sheet 100. Therefore, the magnetic sheet 100 according to the exemplary embodiment of the present invention may be folded between each of the depression parts 120. As a result, the magnetic sheet 100 according to the exemplary embodiments of the present invention may be provided with flexibility to the prominence and depression parts 110 and 120 and may be more flexibly adhered to a bent surface of an object to be adhered.

Meanwhile, in the magnetic sheet 100 according to the exemplary embodiments of the present invention, a protective film 140 (however, not shown in FIG. 2 for clarity) may be adhered to a surface on which the prominence and depression parts 110 and 120 are formed, and an adhesive film 150 may be adhered to an opposite surface to the surface on the prominence and depression parts 110 and 120 are formed.

The protective film 140 may prevent magnetic powder from being separated from the magnetic sheet 100 due to the crack 130. Therefore, it is preferable that the protective film 140 is adhered to the opposite surface along the ‘ [symbol] ’ shape of the prominence and depression parts 110 and 120. As long as a material of the protective film 140 is a resin which has sufficient elasticity so as not to be easily fractured even by folding, there is no particular limitation in the material of the protective film 140.

The adhesive film 150, which is similar to the protective film 140, prevents the magnetic powder from being separated from the magnetic sheet 100, and provides adhesion to the magnetic sheet 100 so as to be stably adhered to the object to be adhered.

Hereinafter, a method for manufacturing the magnetic sheet 100 according to the exemplary embodiments of the present invention will be described.

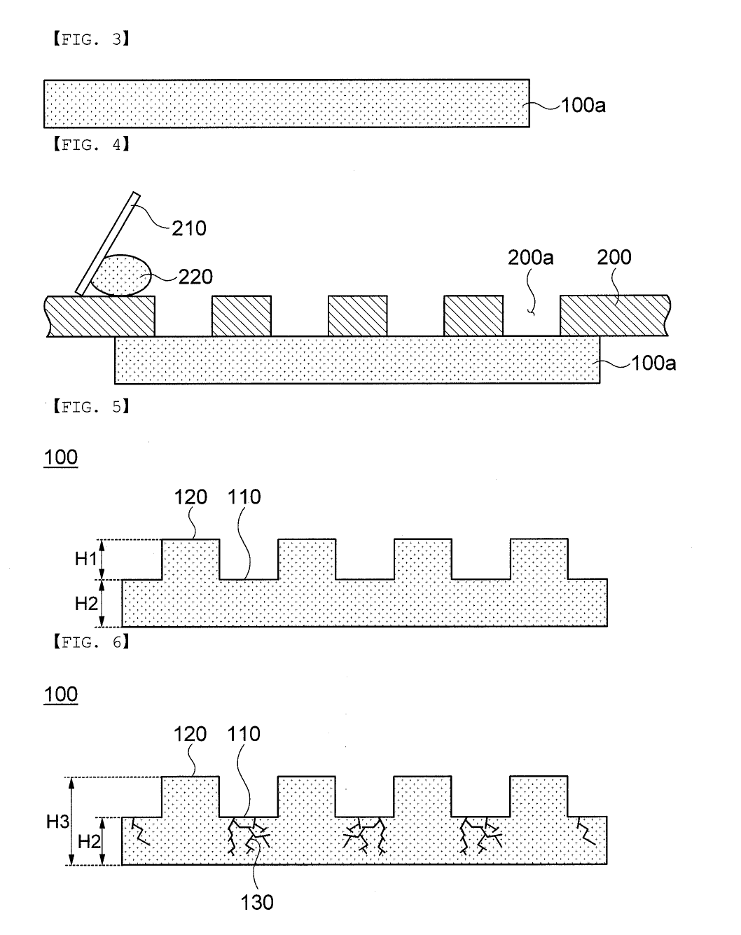

FIGS. 3 to 6 are views sequentially showing a method for manufacturing the magnetic sheet according to the exemplary embodiments of the present invention. Firstly, a green sheet 100a made of a magnetic material is prepared as shown in FIG. 3.

When specifically reviewing a method for manufacturing the green sheet 100a, an organic binder, a plasticizer, and the like, are added in the powder made of any one or two or more compositions of Mn—Zn, Ni—Zn, Fe—Mn, Ni—Zn—Cu, Mn—Mg, Li, and Ba. Then, a wet mixing such as a ball mill or a basket mill is performed to prepare a slurry. Next, a tape casting method is performed on the slurry by using a doctor blade device to manufacture the green sheet 100a having a predetermined thickness, the green sheet is cut so as to have a desired size by using a roll cutter, or the like, and then is finally fired at a predetermined temperature (for example, 850) in a firing furnace.

As shown in FIG. 4, a screen 200 including rectangular shaped opening parts 200a continuously formed on the entire surface thereof is positioned on the green sheet 100a, and a squeegee 210 is used to transfer a magnetic paste 220 on a surface of the green sheet 100a exposed through the opening part 200a.

In the drawings, the screen 200 is shown to be contacted to the green sheet 100a. However, in an actual process, the screen 200 maintains several mm intervals from the green sheet 100a, and is contacted to the green sheet 100a to transfer the magnetic paste 220 on the surface of the green sheet 100a at a moment through which the squeeze 210 passes. At this time, since the opening part 200a has the rectangular shape having a predetermined thickness, a sintering process is performed on the green sheet 100a to which the magnetic paste 220 is transferred through the opening part 200a to thereby manufacture the magnetic sheet 100 having the prominence and depression parts 110 and 120 having a ‘ [symbol] ’ shape as shown in FIG. 5.

That is, in the method for manufacturing the magnetic sheet according to the exemplary embodiments of the present invention, the prominence and depression parts 110 and 120 providing the flexibility to the magnetic sheet, which is manufactured by the screen printing at a time, do not need a half cut process of the related art.

Therefore, even though the thickness of the magnetic sheet has a deviation, the cutting depth does not have to be individually set, and a defect phenomenon of an insulation sheet is not generated due to a cutting error to increase the reliability of the product, increase the productivity thereof and decrease the manufacturing cost.

Here, in order to satisfy the ratio of transversal widths or the ratio of longitudinal widths between the prominence part 110 and the depression part 120 as described above, the opening part 200a formed in the screen 200 has the longitudinal width corresponding to 0.5 to 1.5 of a spaced distance between the opening parts 200a in a longitudinal direction, and similarly, has the transversal width corresponding to 0.5 to 1.5 of a spaced distance between the opening parts 200a in a transversal direction. In addition, the ratio of the thickness of the opening part 200a to the thickness of the green sheet 100a is 0.5 to 1.5 to thereby appropriately set the thickness H1 of the prominence and depression parts 110 and 120 with respect to the spaced distance H2 between the bottom surface of the prominence part 110 and the lower surface of the magnetic sheet 100.

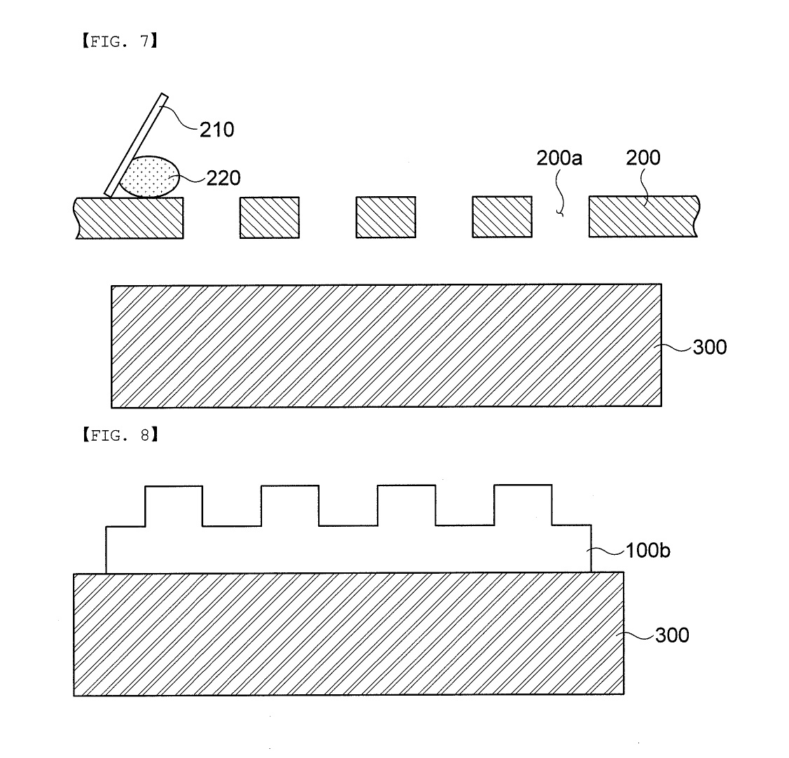

Lastly, a breaking process is performed on the magnetic sheet 100 having the prominence and depression parts 110 and 120 formed thereon. The breaking process includes passing the magnetic sheet between two rollers facing each other to apply a predetermined pressure to an upper and lower portion of the magnetic sheet, wherein the pressure applied to the magnetic sheet has directivity by the prominence and depression parts 110 and 120 to form cracks between the bottom surface of the prominence part 110 and the lower surface of the magnetic sheet 100 as shown in FIG. 6.

That is, since a distance H3 between an upper surface of the depression part 120 and the lower surface of the magnetic sheet 100 is longer than a spaced distance H2 between the bottom surface of the prominence part 110 and the lower surface of the magnetic sheet 100, the pressure applied to the magnetic sheet 100 is added to the prominence part 110, thereby forming the crack 130 between the bottom surface of the prominence part 110 and the lower surface of the magnetic sheet 100.

Meanwhile, although not shown in the drawings, after the sintering process, the protective film 140 may be adhered to the surface on which the prominence and depression parts 110 and 120 are formed in the magnetic sheet, the adhesive film 150 may be adhered to an opposite surface to the surface on which the prominence and depression parts 110 and 120 are formed, and the breaking process may be performed, in order to prevent the magnetic powder from being separated from the crack 130 at the time of breaking process.

As another method for manufacturing the magnetic sheet according to the exemplary embodiments of the present invention, a flat panel 300 having a predetermined area is prepared, the screen 200 is positioned so as to be spaced apart from the flat panel 300 by a predetermined interval, the screen 200 including rectangular shaped opening parts 200a continuously formed on the entire surface thereof, and the magnetic paste 220 is transferred.

Here, the flat panel 300 and the screen 200 are spaced apart from each other by a length obtained by subtracting a thickness of the prominence and depression parts 110 and 120 from the entire thickness of the finally completed magnetic sheet 100. Therefore, as the squeeze 210 moves, the magnetic paste 220 passing through the opening part 200a is transferred to the entire surface of the flat panel 300 to mold a layer having a predetermined thickness, and the depression part having the same shape as the opening part 200a is molded on the layer, and a molded body 100b having the same shape as the finally completed magnetic sheet 100 according to the exemplary embodiments of the present invention is formed as shown in FIG. 8. That is, another method for manufacturing the magnetic sheet according to the exemplary embodiments of the present invention includes performing a screen printing on the magnetic sheet 100 having the prominence and depression parts 110 and 120 so as to be integral with each other.

Then, the sintering process and the breaking process are sequentially performed to finally complete the magnetic sheet 100 having the crack 130 formed between the bottom surface of the prominence part 110 and the lower surface of the magnetic sheet 100.

According to the exemplary embodiments of the present invention, since the prominence and depression parts providing the flexibility to the magnetic sheet are manufactured by the screen printing at a time, the process efficiency may be significantly improved and the manufacturing cost may be reduced as compared to a half-cut process of the related art.

In addition, even though the thickness of the magnetic sheet has a deviation, the cutting depth does not have to be set for each part to decrease the product defect.

Further, the cracks are formed around the prominence part, such that the magnetic sheet may be folded, and be more flexible with respect to the bent part of the object to be adhered.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A magnetic sheet made of a magnetic material, comprising:
prominence and depression parts continuously formed over one surface of the magnetic sheet; and
cracks formed between a bottom surface of the prominence part and a lower surface of the magnetic sheet.

2. The magnetic sheet according to claim 1, wherein the prominence part and the depression part have a ‘ [symbol] ’ shape, respectively.

3. The magnetic sheet according to claim 1, wherein the prominence part has a transversal width corresponding to 0.5 to 1.5 of a transversal width of the depression part.

4. The magnetic sheet according to claim 1, wherein the prominence part has a longitudinal width corresponding to 0.5 to 1.5 of a longitudinal width of the depression part.

5. The magnetic sheet according to claim 1, wherein the prominence and depression part has a thickness 0.5 to 1.5 of a spaced distance between a bottom surface of the prominence part and a lower surface of the magnetic sheet.

6. The magnetic sheet according to claim 1, further comprising a protective film adhered to a surface on which the prominence and depression part is formed in the magnetic sheet, and an adhesive film adhered to an opposite surface to the surface on which the prominence and depression part is formed.

7. A method for manufacturing a magnetic sheet, the method comprising:
(a) preparing a green sheet made of a magnetic material;
(b) positioning a screen on the green sheet, the screen including rectangular shaped opening parts continuously formed on the entire surface thereof;
(c) transferring a magnetic paste on a surface of the green sheet exposed through the opening part;
(d) forming the magnetic sheet having prominence and depression parts on one surface through a sintering process; and
(e) performing a breaking process to form cracks between a bottom surface of the prominence part and a lower surface of the magnetic sheet.

8. The method according to claim 7, wherein the opening part has a longitudinal width corresponding to 0.5 to 1.5 of a spaced distance between the opening parts in a longitudinal direction.

9. The method according to claim 7, the opening part has a transversal width corresponding to 0.5 to 1.5 of a spaced distance between the opening parts in a transversal direction.

10. The method according to claim 7, wherein the opening part has a thickness corresponding to 0.5 to 1.5 of a thickness of the green sheet.

11. The method according to claim 7, further comprising, after the forming of the magnetic sheet, adhering a protective film to a surface on which the prominence and depression part is formed, and adhering an adhesive film to an opposite surface to the surface on which the prominence and depression part is formed.

12. A method for manufacturing a magnetic sheet, the method comprising:
(a) positioning a screen so as to be spaced apart from a flat panel by a predetermined interval, the screen including rectangular shaped opening parts continuously formed on the entire surface thereof;
(b) transferring a magnetic paste on the screen;
(c) sintering a molding body formed by the transferring of the magnetic paste to form a magnetic sheet having a prominence and depression part on one surface thereof; and
(d) performing a breaking process to form cracks between a bottom surface of the prominence part and a lower surface of the magnetic sheet.
